(19) United States
(12) Patent Application Publication
(10) Pub. No.: US 2021/0376332 A1
(43) Pub. Date: Dec. 2, 2021

(54) ACTIVE ELEMENT FOR AN ELECTROCHEMICAL APPARATUS

(71) Applicant: 2706649 Ontario Ltd, Aurora (CA)

(72) Inventors: Debbie MAGUIRE, Evansville, IN (US); Mark FERTMAN, Toronto (CA)

(21) Appl. No.: 17/332,624

(22) Filed: May 27, 2021

(30) Foreign Application Priority Data
May 29, 2020 (EP) 20177412.2

(51) Int. Cl. H01M 4/66; H01M 4/74; H01M 4/78

(52) U.S. Cl. CPC H01M 4/661; H01M 4/663; H01M 2004/027; H01M 4/742; H01M 4/78; H01M 4/667

(57) ABSTRACT

The active element of an electrochemical apparatus for producing electrical power and/or hydrogen may be formed as a massive metal body or a mesh-type or perforated sheet-type support structure. The support structure may be made from at least one of magnesium, zinc, aluminum, manganese, iron, or titanium, or an alloy of at least one of these, and may include a coating of boron enhanced carbon/graphite/graphene or a boron enhanced material. The boron enhanced material may include at least two elements selected from carbon/graphite/graphene, nickel, tungsten, phosphorous, and copper.

### CROSS REFERENCES

The following application is incorporated herein, in its entirety, for all purposes: U.S. patent application Ser. No. 17/107,412, filed Nov. 30, 2020.

### SUMMARY

The present disclosure provides systems, apparatuses, and methods relating to active elements of electrochemical apparatuses for producing electrical power and/or hydrogen.

In some embodiments, an active element of an electrochemical apparatus for producing electrical power and/or hydrogen may be formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium, and comprising a coating of boron-enhanced carbon/graphite/graphene or a boron-enhanced material which comprises at least two elements selected from the group consisting of carbon/graphite/graphene, nickel, tungsten, phosphorous, and copper.

In some embodiments, an electrochemical apparatus for producing electrical power and/or hydrogen may include an active element formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium; wherein the active element has a coating of boron-enhanced carbon/graphite/graphene.

In some embodiments, an electrochemical apparatus for producing electrical power and/or hydrogen may include an active element formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium; wherein the active element has a coating of a boron-enhanced material which comprises at least two elements selected from the group consisting of carbon/graphite/graphene, nickel, tungsten, phosphorous, and copper.

Features, functions, and advantages may be achieved independently in various embodiments of the present disclosure, or may be combined in yet other embodiments, further details of which can be seen with reference to the following description and drawings.

### DETAILED DESCRIPTION

Various aspects and examples of active elements of electrochemical apparatuses for producing electrical power and/or hydrogen, as well as related methods, are described below and illustrated in the associated drawings. Unless otherwise specified, an active element_in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“wt.-%” means percentage by weight.

In this disclosure, one or more publications, patents, and/or patent applications are incorporated by reference. However, such material is only incorporated to the extent that no conflict exists between the incorporated material and the statements and drawings set forth herein. In the event of any such conflict, including any conflict in terminology, the present disclosure is controlling.

### Examples, Components, and Alternatives

The following sections describe selected aspects of illustrative active elements of electrochemical apparatuses for producing electrical power and/or hydrogen, as well as related systems and/or methods. The examples in these sections are intended for illustration and should not be interpreted as limiting the scope of the present disclosure. Each section may include one or more distinct embodiments or examples, and/or contextual or related information, function, and/or structure.

The present disclosure relates to an active element of an electrochemical apparatus for producing electrical power and/or hydrogen. The active element is formed as a massive metal body or a mesh-type or perforated sheet-type support structure made from at least one of magnesium, zinc, aluminum, manganese, iron, or titanium, or an alloy of at least one of these, and comprising an active surface layer. It further relates to a process for making such active element and to an electrochemical apparatus comprising such active element.

The function and efficiency of electrochemical apparatus, including electrical power generating apparatus and hydrogen generating apparatus, can be considerably improved by appropriate materials for the major components thereof, in particular components which are crucial for the electrochemical processes in the apparatus and which herein below are referred to as “active elements”. These are, in particular, anode or cathode elements of an electrochemical battery, or catalyzer elements or hydrogen-developing elements in a hydrogen generating apparatus.

Developing and using materials, in particular surface materials, of superior efficiency in such apparatus can result in highly improved efficiency thereof and may open new applications and vastly broader markets for such apparatus.

Improvements in this regard are disclosed in the non-published European Patent Application 19212000.4 of the same applicant.

The present disclosure provides an active element of the above-referenced type which is highly efficient both under cost and performance aspects, and a process for making the same. Furthermore, an electrochemical apparatus comprising such improved active elements shall be provided.

According to a first aspect of the present disclosure, the active element comprises a coating of boron-enhanced carbon or boron-enhanced graphite or boron-enhanced graphene. According to a second aspect of the present disclosure, the active element comprises a surface layer of a boron-enhanced material which comprises at least two elements selected from the group consisting of carbon or graphite or graphene, nickel, tungsten, phosphorous, and copper.

Where, in the following description, “carbon or graphite or graphene” or “carbon/graphite/graphene” are mentioned, it shall be clear that the chemical element in the coating is carbon and that it can exist in several modifications, in particular those which are known as graphite or graphene. Mixed morphological/structural configurations can also be advantageous, e.g. carbon nanoparticles mixed with graphite and/or graphene. It should also be noted that such modifications of carbon can be available as commercial products or can be formed in the course of the depositing of the coating in an electroless bath. By way of an appropriate adjustment of the deposition parameters, the existence and ratio of such modifications/configurations can be controlled in line with the required parameters of the active element.

In some embodiments, the carbon/graphite constituent of the coating comprises carbon nanoparticles or nanotubes. Such embodiments provide for a very large active surface area, which further improves the electrochemical efficiency of the active element.

In an embodiment of the present disclosure, the massive body or support structure comprises a ferrous or titanium-based alloy and a coating of electroless nickel co-deposited with boron and at least one of tungsten and carbon/graphite/graphene. Such active element is suitable to form an anode element of an electrochemical battery or a hydrogen-developing element of a hydrogen generating apparatus with superior respective electrochemical efficiency.

In a further embodiment of the present disclosure, the massive body or support structure comprises aluminum and a coating of boron-enhanced graphite or of electroless nickel co-deposited with boron and at least one of phosphorous, tungsten, carbon/graphite/graphene and copper. Such an active element is suitable to form a cathode element of an electrochemical battery or a catalyzer element of a hydrogen generating apparatus with less production cost and superior respective electrochemical efficiency.

Aluminum, in particular, is a good basic material for active elements, due to its low price and superior workability, in particular for foil-type support structures which can be used in small-size electrochemical batteries.

In an exemplary embodiment, the coating of the active element is primarily nickel, with between 3 and 6 wt.-% tungsten, 1 and 3 wt.-% boron, 3 and 5 wt.-% phosphorous, 0.5 to 1 wt.-% copper, 0.05 to 0.20 wt.-% carbon nanoparticles and 0.1 to 1 wt.-% graphite. Depending on the specific application, the percentage values of the several elements can vary, and the content of some of the elements can be approximately zero.

In another exemplary embodiment, according to the above-referenced first aspect of the present disclosure, the coating is primarily carbon or graphite or graphene, respectively, comprising between 1.5 wt.-% and 20 wt.-%, preferably between 2 wt.-% and 10 wt.-%, of boron.

In further embodiments, the coating is an electroless deposited coating which has a medium or median thickness between 20 μm and 500 μm, preferably between 50 μm and 200 μm. According to the peculiarities of specific applications, different values can be appropriate.

In further embodiments, the coating comprises a nano- or microporous surface having a surface roughness in the range between 50 nm and 100 μm, preferably between 100 nm and 50 μm and more preferably between 500 nm and 5 μm. The specific surface roughness can be adapted to the respective application and geometric configuration of an electrochemical apparatus, wherein the active element is being used.

In further embodiments, the massive body or support structure comprises an overall flat, cylindrical, or spiral plate shape. The term “plate shape” includes mesh-type or grid-type support structures and foils. Other geometrical configurations, e.g. small balls arranged in a grid or mesh-type holder, or appropriately supported filaments, can be useful embodiments in specific fields and for specific purposes.

The inventive deposition of the coating from an electroless bath, in particular nickel-based bath, facilitates the production of active elements with precisely predetermined surface morphology, superior electrochemical performance and long lifetime, due to the excellent adherence of the coating to the surface of the metal body or support structure, respectively.

In some embodiments, the electrochemical apparatus comprising at least one active element according to the present disclosure is an electrical battery. Such battery can, in particular, comprise an aluminum or magnesium or manganese based active element as an anode element. Also, it can comprise an iron- or titanium based active element as a cathode element.

In further embodiments, such electrochemical apparatus (e.g., battery) comprises an alkaline or saline aqueous electrolyte, in particular comprising potassium hydroxide or potassium chloride or a manganese compound. More specifically, in a cost-efficient embodiment which provides a high performance in generating electrical power, the active element comprises aluminum and the aqueous electrolyte comprises potassium hydroxide or potassium chloride.

The above embodiments and aspects of the present disclosure are not determined to restrict the scope of the appending claims but to illustrate preferred configurations and applications of the present disclosure. In particular, any combinations of the features of the claims and of the above-mentioned embodiments and aspects, which are within the skills of one of ordinary skill in the art, shall be considered as being with the scope of the present disclosure.

### Illustrative Combinations and Additional Examples

This section describes additional aspects and features of innovative active elements of electrochemical apparatuses for producing electrical power and/or hydrogen, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. An active element of an electrochemical apparatus for producing electrical power and/or hydrogen, the active element being formed as a massive metal body or a mesh-type or perforated sheet-type support structure made from at least one of magnesium, zinc, aluminum, manganese, iron, or titanium, or an alloy of at least one of these, and comprising a coating of boron enhanced carbon/graphite/graphene or a boron enhanced material which comprises at least two elements selected from the group comprising carbon/graphite/graphene, nickel, tungsten, phosphorous, and copper.

A1. The active element of A0, wherein the massive body or support structure comprises a ferrous or titanium based alloy and a coating of electroless nickel co-deposited with boron and at least one of tungsten and carbon/graphite.

A2. The active element of A0, wherein the massive body or support structure comprises aluminum and a coating of electroless nickel co-deposited with boron and at least one of phosphorous, tungsten, carbon/graphite/graphene and copper.

A3. The active element of A0, wherein the massive body or support structure comprises aluminum and a coating which primarily contains carbon/graphite/graphene and between 1.5 wt.-% and 20 wt.-%, preferably between 2 wt.-% and 10 wt.-%, boron.

A4. The active element of any one of paragraphs A0 through A3, wherein the carbon/graphite/graphene constituent of the coating comprises carbon nanoparticles or nanotubes.

A5. The active element of any one of paragraphs A0 through A4, wherein the coating has a medium or median thickness between 20 μm and 500 μm, preferably between 50 μm and 200 μm.

A6. The active element of any one of paragraphs A0, A1, A2, or A4, wherein the coating is primarily nickel, with between 3 and 6 wt.-% tungsten, 1 and 3 wt.-% boron, 3 and 5 wt.-% phosphorous, 0.5 to 1 wt.-% copper, 0.05 to 0.20 wt.-% carbon nanoparticles and 0.1 to 1 wt.-% graphite.

A7. The active element of any one of paragraphs A0 through A6, wherein the coating comprises a nano- or microporous surface having a surface roughness in the range between 50 nm and 100 μm, preferably between 100 nm and 50 μm and more preferably between 500 nm and 5 μm.

A8. The active element of any one of paragraphs A0 through A7, wherein the massive body or support structure comprises an overall flat, cylindrical or spiral plate shape.

B0. A process for making an active element of any one of paragraphs A0 through A8, wherein the massive body or support structure is being immersed into an electroless poly-metallic bath comprising a nickel cation source, boron and at least one additional element selected from tungsten, carbon/graphite, phosphorous, and copper.

C0. An electrochemical apparatus producing electrical power and/or hydrogen, the apparatus comprising at least one active element of any one of paragraphs A0 through A8.

C1. The electrochemical apparatus of C0, adapted for producing electrical power and comprising an aluminum or magnesium or manganese based active element of any one of paragraphs A0 through A8 as an anode element.

C2. The electrochemical apparatus of C0, adapted for producing electrical power and comprising a ferrous or titanium based active element of one of any one of paragraphs A0 through A8 as a cathode element.

C3. The electrochemical apparatus of any one of paragraphs C0 through C2, comprising an alkaline or saline aqueous electrolyte, in particular comprising potassium hydroxide or potassium chloride or a manganese compound.

C4. The electrochemical apparatus of C3, wherein the active element comprises aluminum and the aqueous electrolyte comprises potassium hydroxide or potassium chloride.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An active element of an electrochemical apparatus for producing electrical power and/or hydrogen, the active element being formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium, and comprising a coating of boron-enhanced carbon/graphite/graphene or a boron-enhanced material which comprises at least two elements selected from the group consisting of carbon/graphite/graphene, nickel, tungsten, phosphorous, and copper.

2. The active element of claim 1, wherein the massive metal body or support structure comprises a ferrous or titanium based alloy and a coating of electroless nickel co-deposited with boron and at least one of tungsten and carbon/graphite.

3. The active element of claim 1, wherein the massive metal body or support structure comprises aluminum and a coating of electroless nickel co-deposited with boron and at least one of phosphorous, tungsten, carbon/graphite/graphene, and copper.

4. The active element of claim 1, wherein the massive metal body or support structure comprises aluminum and a coating comprising carbon/graphite/graphene and between 1.5 wt.-% and 20 wt.-% boron.

5. The active element of claim 4, wherein the massive metal body or support structure comprises aluminum and a coating comprising carbon/graphite/graphene and between 2 wt.-% and 10 wt.-% boron.

6. The active element of claim 1, wherein the coating includes carbon/graphite/graphene as a constituent, and the carbon/graphite/graphene constituent of the coating comprises carbon nanoparticles or nanotubes.

7. The active element of claim 1, wherein the coating has a median thickness between 20 μm and 500 μm.

8. The active element of claim 7, wherein the coating has a median thickness between 50 μm and 200 μm.

9. The active element of claim 1, wherein the coating comprises nickel, with between 3 and 6 wt.-% tungsten, 1 and 3 wt.-% boron, 3 and 5 wt.-% phosphorous, 0.5 to 1 wt.-% copper, 0.05 to 0.20 wt.-% carbon nanoparticles, and 0.1 to 1 wt.-% graphite.

10. The active element of claim 1, wherein the coating comprises a nano- or microporous surface having a surface roughness in a range between 50 nm and 100 μm.

11. The active element of claim 10, wherein the coating comprises a nano- or microporous surface having a surface roughness in a range between 500 nm and 5 μm.

12. The active element of claim 1, wherein the massive metal body or support structure comprises an overall flat, cylindrical, or spiral plate shape.

13. An electrochemical apparatus producing electrical power and/or hydrogen, wherein the apparatus comprises the active element of claim 1.

14. The electrochemical apparatus of claim 13, adapted for producing electrical power, wherein the active element is an anode element and is aluminum or magnesium or manganese based.

15. The electrochemical apparatus of claim 13, adapted for producing electrical power, wherein the active element is a cathode element and is ferrous or titanium based.

16. The electrochemical apparatus of claim 13, further comprising an alkaline or saline aqueous electrolyte.

17. The electrochemical apparatus of claim 16, wherein the active element comprises aluminum and the aqueous electrolyte comprises potassium hydroxide or potassium chloride.

18. An electrochemical apparatus for producing electrical power and/or hydrogen, the apparatus comprising:
an active element formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium;
wherein the active element has a coating of boron-enhanced carbon/graphite/graphene.

19. An electrochemical apparatus for producing electrical power and/or hydrogen, the apparatus comprising:
an active element formed as a massive metal body or a mesh-type or perforated sheet-type support structure made from at least one of magnesium, zinc, aluminum, manganese, iron, and titanium, or an alloy of at least one of magnesium, zinc, aluminum, manganese, iron, and titanium;
wherein the active element has a coating of a boron-enhanced material which comprises at least two elements selected from the group consisting of carbon/graphite/graphene, nickel, tungsten, phosphorous, and copper.
